(19) United States
(12) Patent Application Publication
(10) Pub. No.: US 2024/0116379 A1
(43) Pub. Date: Apr. 11, 2024

(54) Positioning Unit and Contacting Method

(71) Applicants: Schunk Transit Systems GmbH, Wettenberg (DE); Schunk Transit Systems GmbH, Nussdorf am Haunsberg (AT)

(72) Inventors: Martin Feldinger, Seekirchen am Wallersee (AT); Nils Drewes, Giessen (DE); Timo Staubach, Herbstein (DE)

(21) Appl. No.: 18/546,151

(22) PCT Filed: Feb. 17, 2021
(86) PCT No.: PCT/EP2021/053906

§ 371 Date: Aug. 17, 2023

(51) Int. Cl. B60L 53/35; B60L 53/16

(52) U.S. Cl. CPC B60L 53/35; B60L 53/16

(57) ABSTRACT

A positioning unit and a method for forming an electrically conductive connection between an electrically driven vehicle, and a stationary charging station using a positioning unit, in which the positioning unit is configured to be disposed on a vehicle roof, a contact device of the positioning unit being configured to be moved relative to a charging contact device of the charging station and to make electrical contact therewith in a contact position, the positioning unit having an articulated arm device for positioning the contact device and a drive device for driving the articulated arm device, the articulated arm device having a pivoting device with a pivoting arm, the pivoting device being configured to pivot the contact device from a storage situation into a contact situation and vice versa. The positioning unit comprises a securing device configured to secure the pivoting arm in the storage situation in a form-fitting manner.

This patent application represents the U.S. national phase filing of international patent application no. PCT/EP2021/053906 filed on Feb. 17, 2021, the disclosure of which is incorporated herein by reference.

The disclosure relates to a positioning unit for electrically driven vehicles, in particular electric busses or the like, and to a method for forming an electrically conductive connection between an electrically driven vehicle and a stationary charging station, the positioning unit being configured to be disposed on a vehicle roof, a contact device of the positioning unit being configured to be moved relative to a charging contact device of the charging station and to make electrical contact therewith in a contact position, the positioning unit having an articulated arm device for positioning the contact device and a drive device for driving the articulated arm device, the articulated arm device having a pivoting device with a pivoting arm configured to rotate on a pivot axis, the pivoting device being configured to pivot the contact device from a storage situation of a retracted position of the positioning unit for storing the contact device into a contact situation in the contact position and vice versa.

Positioning units and methods of this kind are known from the prior art and are regularly used in connection with electrically driven vehicles which travel between bus stops, for example. These vehicles can be electric buses, but also other vehicles, in principle, such as a train or a streetcar, which are not permanently connected to a contact wire or similar. An electric energy storage unit of these vehicles is charged by a charging station when travel is interrupted at a stop. The vehicle is electrically connected to the charging station at the stop, the energy storage unit being charged at least to the extent that the vehicle can reach the next stop with a charging station to be approached. It is also possible to supply the vehicle with electrical energy outside operating hours in this way.

To establish an electrical connection between the vehicle and the charging station, a positioning unit is used, which can be mounted on a vehicle roof and connects a contact device of the vehicle with a charging contact device of the charging station above the vehicle. Contact surfaces of the contact device are then moved towards charging contact surfaces above the roof of the vehicle and an electrical connection is established. Such a positioning unit is known, for example, from WO 2015/018887. Since the contact device must be positioned comparatively precisely on the charging contact device and pressed against the charging contact surfaces with sufficient contact force in order to form a secure electrical connection, fault-free functioning of the articulated arm device and the drive device must be ensured at all times. The numerous moving components of the articulated arm device and the drive device can easily be damaged during operation, for example by mechanical impacts such as shocks, blows, accelerations, vibrations or the like. As a result, the positioning unit is subject to increased wear, making it necessary to maintain it at regular intervals and to replace damaged or worn components as required.

Therefore, the object is to propose a positioning unit and a method for forming an electrically conductive connection between an electrically driven vehicle and a stationary charging station which require low maintenance.

This object is attained by a positioning unit as disclosed herein, a fast charging system as disclosed herein, and a method as disclosed herein.

The positioning unit according to this disclosure for electrically driven vehicles, in particular electric busses or the like, serves to form an electrically conductive connection between a vehicle and a stationary charging station, the positioning unit being configured to be disposed on a vehicle roof, a contact device of the positioning unit being configured to be moved relative to a charging contact device of the charging station and to make electrical contact therewith in a contact position, the positioning unit having an articulated arm device for positioning the contact device and a drive device for driving the articulated arm device, the articulated arm device having a pivoting device with a pivoting arm configured to rotate on a pivot axis, the pivoting device being configured to pivot the contact device from a storage situation of a retracted position of the positioning unit for storing the contact device into a contact situation in the contact position and vice versa, wherein the positioning unit comprises a securing device configured to secure the pivoting arm in the storage situation in a form-fitting manner.

Accordingly, a movement of the contact device relative to a charging contact device of a charging station disposed above the contact device is performed by the articulated arm device with the drive device. The contact device can have a number of contacts which are in electrical contact with charging contacts of the charging contact device. The essential aspect is that the contact device is in a vertical situation when in the contact position, i.e., that a vertical axis of the contact device is aligned orthogonally or vertically in relation to the charging contact device so that contacting can take place at all. Consequently, the contact device is in the vertical contact situation when in the contact position. During driving operation of the vehicle, the contact device is regularly in the storage situation in order to protect the contact device from damage and to enable driving under bridges or the like. Since the contact device and the pivoting arm form movable masses, a driving movement of the vehicle also sets the contact device and the pivoting arm in motion, which is prevented by the securing device according to this disclosure. The fact that the pivoting arm can be positively fixed in the storage situation by means of the securing device makes it possible to effectively prevent movement of the pivoting arm with the contact device. Shocks and vibrations that can be transmitted to the pivoting arm and the contact device via the vehicle during driving operation then do not cause any movement of the pivoting arm and the contact device, such as a movement out of the storage situation or an oscillation after a driving movement. The securing device thus restrains a possible movement of the pivoting arm in all degrees of freedom, meaning the securing device can eliminate a possible cause of damage and thus wear of the positioning unit during driving operation. Repairs and maintenance of the positioning unit are required less frequently as a result.

The articulated arm device may be configured to position the contact device in the vertical direction and the horizontal direction relative to the charging contact device and to move it into the contact position. In particular, when the pivoting arm is pivoted relative to a vehicle roof, the contact device can be moved in at least one radius or circular path around a pivot bearing of the pivoting arm. By moving in a circular path, a horizontal displacement of the contact device can take place with a simultaneous vertical displacement. In this respect, it is then also advantageous if the charging contact device is configured in such a manner that the contact device can make electrical contact with it at various points in the horizontal direction. For example, the positioning unit can be mounted on a vehicle roof in such a manner that the movement of the contact device in the horizontal direction runs along a direction of travel of the vehicle. The contact device is then pivoted in the direction of a plane running in the direction of travel.

The securing device can be coupled to the drive device in such a manner that when the contact device is pivoted into the storage situation, the contact device can be secured in the storage situation by means of the securing device, and when the contact device is pivoted into a contact situation in the retracted position, the contact device can be released by the securing device. The securing device can be mechanically connected to the drive device, allowing the securing device to be operated or switched via the drive device. Since the pivoting of the contact device or the pivoting arm takes place by means of the drive device, the securing device can lock and release the pivoting arm in the storage situation when the contact device is moved from the storage situation into the contact position. In the retracted position, the contact device can already be moved into the or a contact situation. Thus, a large range within which a charging contact device can make electrical contact with the contact device can be formed between the retracted position and the contact position. Consequently, the contact device may be positionable with the articulated arm device between a lower contact position and an upper contact position.

The contact device may be disposed on an end of the pivoting arm opposite to the pivot axis in such a manner that it can rotate on another pivot axis, wherein the pivoting device may be configured to pivot the contact device from the storage situation of the retracted position into a vertical contact situation in the retracted position and vice versa. If the contact device is disposed on the distal end of the pivoting arm in a pivotable manner, the contact device can be pivoted into the vertical contact situation and the storage situation. This can also take place when the pivoting arm is not moved and is located in the retracted position. The contact device can therefore also be located in the vertical contact situation when in the contact position. Thus, it is possible to pivot the contact device or to bring it into the vertical contact situation irrespective of the situation of the pivoting arm. This can also be made possible, for example, by the fact that the articulated arm device is designed in the form of a parallelogram or a linkage. For instance, a guide bar of the articulated arm device can be disposed parallel to the pivoting arm, the guide bar positioning the contact device in the desired situation irrespective of a position of the pivoting arm. The vertical contact situation of the contact device can thus be assumed at different heights, resulting in a comparatively large range within which the contact device can be brought into a contact position. It is then no longer necessary to mount different charging contact devices along a route at essentially the same height above a roadway and to adapt them to a vehicle type.

In the storage situation, the contact device can be pivoted in one direction of the pivot axis of the pivoting arm and rest on the latter or be pivoted in a direction opposite to the pivoting arm. A structural height of the articulated arm device in the storage situation can then be comparatively low. The pivoting arm can also be cranked so that the contact device can be in contact with a portion of the pivoting arm which is positioned horizontally or at an angle. Alternatively, the pivoting arm with the contact device in the storage situation can be pivoted in the opposite direction, away from the pivoting arm, in which case a length of the articulated arm device on the roof of the vehicle is then comparatively increased. In this respect, it is advantageous for the articulated arm device to be disposed as compactly as possible on the roof of the vehicle in the storage situation.

The positioning unit may comprise a frame for mounting the positioning unit on a roof of a vehicle, wherein the pivoting arm may be pivotably disposed with the pivot axis on the frame. The frame may, for example, be designed in the manner of a frame and form or have a fixed bearing for the pivoting arm and the drive device. The frame can also be particularly easily attached to a roof of a vehicle. For example, it can be attached by means of damping elements which dampen vibrations and/or vehicle movements.

The securing device can be formed by a latch and a recess, in which case the latch can engage the recess in the storage situation and firmly secure the pivoting arm; the latch can be disposed on the pivoting arm and the recess can be disposed on the frame, or vice versa. The latch and the recess can thus form a lock which fixes a situation of the pivoting arm in such a manner that the pivoting arm is no longer movable. The latch and the recess can optionally be disposed on the pivoting arm or the frame. Depending on the arrangement and design of the drive device, the latch or the recess can also be disposed on a component of the drive device, for example on a cylinder or on a linear drive, if this component of the drive device is connected to the frame. This also makes it possible to secure the pivoting arm in the storage situation by means of the securing device.

The latch can be a profile bar configured to move in a linear guide of the securing device, a catch or a pivoting hook, and the recess can be formed by a protrusion, an edge, a hook, an eye or a bracket. The essential aspect is that the latch and the recess are configured to mate in such a manner that the latch can engage the recess and secure the pivoting arm in a form-fitting manner. For example, the latch can be formed by a round bar which can be longitudinally inserted into an eye. This makes the securing device particularly simple and inexpensive to realize.

The drive device can have an adjustment drive for generating an adjusting force acting on the pivoting arm and a spring element mechanically cooperating with the adjustment drive. The adjustment drive can interact with the spring element in such a manner that the adjusting force alone can cause a movement of the pivoting arm with the contact device. The adjustment drive can interact directly with the spring element or be connected to the pivoting arm via an additional mechanical component, such as a lever. The spring element can, for example, comprise a tension, compression or torsion spring, which acts on the pivot axis of the pivoting arm via a lever and thus exerts an adjusting force on the pivoting arm, the adjusting force moving the pivoting arm into the retracted position or alternatively into the contact position. For example, in the event of failure of the adjustment drive, the spring element may move the articulated arm device into the retracted position to prevent any faulty contact.

The drive device can have another adjustment drive for generating an adjusting force acting on the contact device. Like the adjustment drive, the other adjustment drive can be formed by a spring element which exerts an adjusting force on the contact device. The other adjustment drive makes it possible to adjust the contact device independently of an adjustment of the pivoting arm. Nevertheless, the adjustment drive may be functionally coupled with the other adjustment drive.

The adjustment drive and/or the other adjustment drive can have an electric motor, a cable drive and/or chain drive via which the pivoting arm can be rotated on the pivot axis and/or the contact device can be rotated on another pivot axis. For example, an electric motor can be disposed directly on the pivot axis or integrated within it. Furthermore, a cable drive and/or a chain drive which is attached to the pivot axis can be used to exert a pulling force on the pivoting arm. For example, two cables or one chain drive which can pivot the pivoting arm by moving in opposite directions can be disposed on the pivot axis. The cable drive or the chain drive can also be actuated by means of an electric motor, which can then be disposed on a frame of the positioning unit at a distance from the pivoting arm. It is also possible to use a cable drive and a chain drive in combination. The chain drive can be formed by a chain which runs over a gearwheel on the pivot axis and is connected to a cable or a Bowden cable at its respective ends. The other adjustment drive for pivoting the contact device can also be designed according to one of the above examples. The adjustment drive and the other adjustment drive can have an electric motor or a linear drive, preferably a spindle drive. The adjustment drive or the other adjustment drive can have a displacement sensor, which can be an incremental encoder or an absolute encoder. In this case, it is possible to always determine an exact working position of the adjustment drive in question. The adjustment drives can also have position-dependent limit switches and/or force-dependent pressure switches. Furthermore, pressure switches for limiting a contact force or an adjusting force can also be used.

The securing device can be operably coupled to the cable drive or the chain drive of the adjustment drive or the other adjustment drive. For example, a latch of the securing device which engages a recess of the securing device can be disposed on the cable drive or the chain drive. Depending on the position of the cable drive or the chain drive which determines a situation of the pivoting arm or contact device, the pivoting arm can then be secured or released by the securing device. If the latch is actuated by the cable drive or the chain drive, it is no longer necessary to provide a specially designed actuation of the securing device.

The contact device may have a charging contact element carrier with contact elements, wherein the contact elements can be configured to make electrical contact with charging contact elements of the charging contact device when in the contact position so as to form respective contact pairs. The charging contact element carrier can be configured in such a manner that the contact elements are disposed on an upper side of the charging contact element carrier when the contact device is in the vertical contact situation. The charging contact elements may, for example, be formed as conductor strips disposed on a roof-shaped charging contact element carrier of the charging contact device.

The pivoting device can have a transverse guide configured to position the contact device in the direction perpendicular to the charging contact device, wherein the transverse guide can be disposed on an end of the pivoting arm opposite the pivot axis. Thus, the contact device can then be displaced on the end of the pivoting arm perpendicular to the direction of travel of the vehicle. This displaceability can be used, for example, to compensate for a deviating positioning of the vehicle at a stop perpendicular to the direction of travel. Moreover, possible vehicle movements as a result of a one-sided lowering of the vehicle for the entry and exit of persons can be compensated in such a manner that no displacement of the contact device relative to the charging contact device in the transverse direction can occur. Also, no transverse forces are exerted on the pivoting arm. The transverse guide can be a straight linear guide or an arcuate linear guide. The contact device can be disposed on the transverse guide in such a manner that it is freely displaceable, wherein the transverse guide can be configured as a guide rail or with guide profiles for the contact device. Furthermore, the contact device may be centered on the transverse guide, i.e., aligned centrally relative to the transverse guide in a rest position or in a non-contact position, for example by means of springs.

The fast charging system according to this disclosure comprises a charging contact device and a positioning unit according to this disclosure. Further advantageous embodiments of the fast charging system are apparent from the description herein.

In the method according to this disclosure for forming an electrically conductive connection between an electrically driven vehicle, in particular an electric bus or the like, and a stationary charging station using a positioning unit, a contact device of the positioning unit is moved relative to a charging contact device of the charging station and makes electrical contact with the latter in a contact position, an articulated arm device of the positioning unit positioning the contact device, and a drive device of the positioning unit driving the articulated arm device, the articulated arm device having a pivoting device with a pivoting arm configured to rotate on a pivot axis, the pivoting device pivoting the contact device from a storage situation of a retracted position of the positioning unit for storing the contact device into a contact situation of the contact position and vice versa, wherein a securing device of the positioning unit secures the pivoting arm in the storage situation in a form-fitting manner. Regarding the advantages of the method according to this disclosure, reference is made to the description of advantages of the positioning unit according to this disclosure.

The contact device can first be pivoted from the storage situation into a vertical contact situation and subsequently into the contact position in the vertical contact situation and vice versa. In the storage situation, the positioning unit can then have a minimum structural height. When approaching a stop with a vehicle, the contact device can then be pivoted from the storage situation to the vertical contact situation in a first step.

Furthermore, during pivoting of the contact device with the pivoting arm, the pivoting device can always position the contact device in the vertical contact situation. After pivoting the contact device into the vertical contact situation, pivoting the pivoting arm with the contact device can raise the contact device in the vertical contact situation and move it against a charging contact device in a second step. It is advantageous if the contact device is always positioned vertically during the pivoting of the pivoting arm or the pivoting arm is pivoted relative to the contact device. This simultaneous movement of the pivoting arm and the contact device can be effected by a suitable mechanism or control of the drive device. In any case, this makes it possible for the contact device to make electrical contact with a charging contact device in a range between an upper contact position and a lower contact position.

Further advantageous embodiments of the method are apparent from the description of features herein.

Hereinafter, preferred embodiments of the disclosure are explained in more detail with reference to the accompanying drawings.

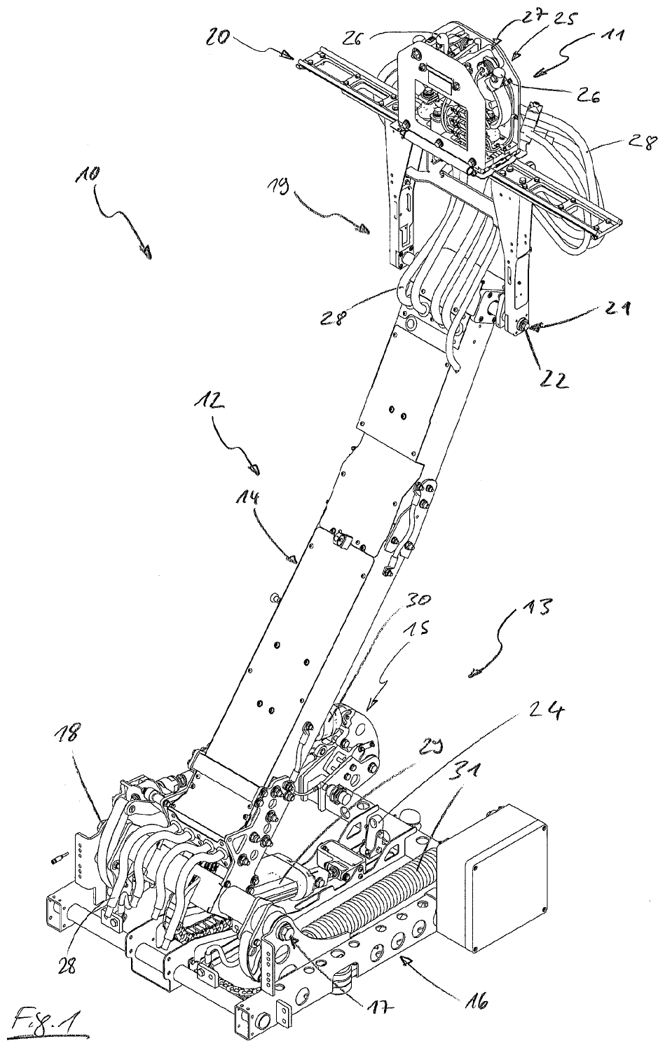

FIG. 1 is a perspective view of a positioning unit;

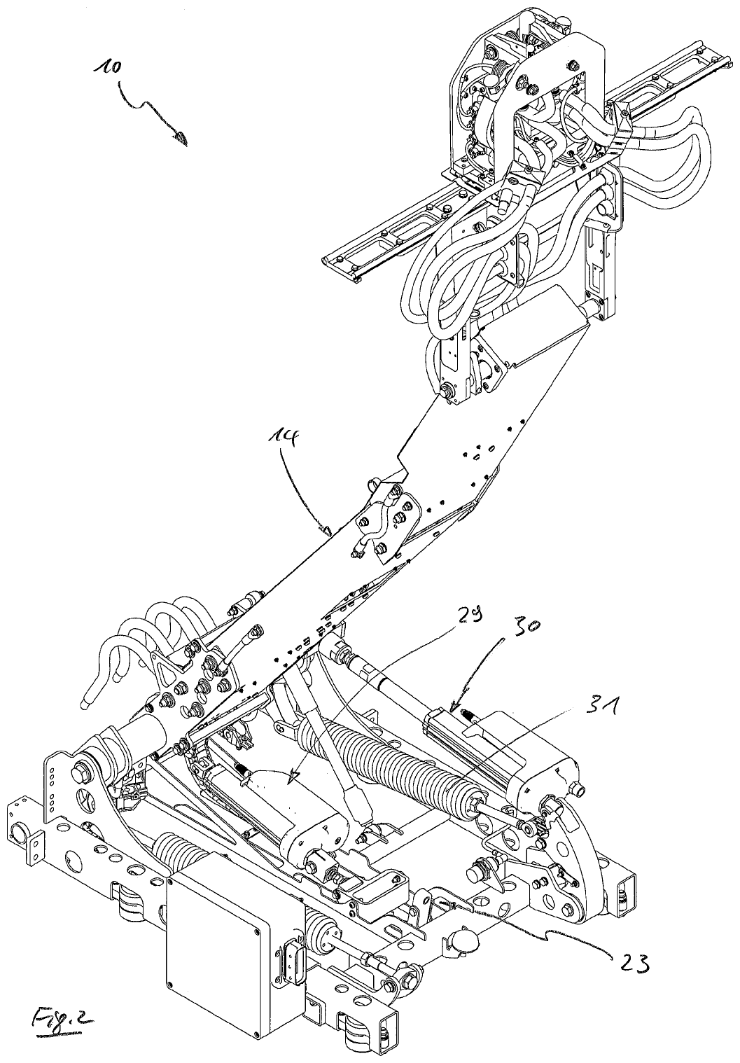

FIG. 2 is another perspective view of the positioning unit;

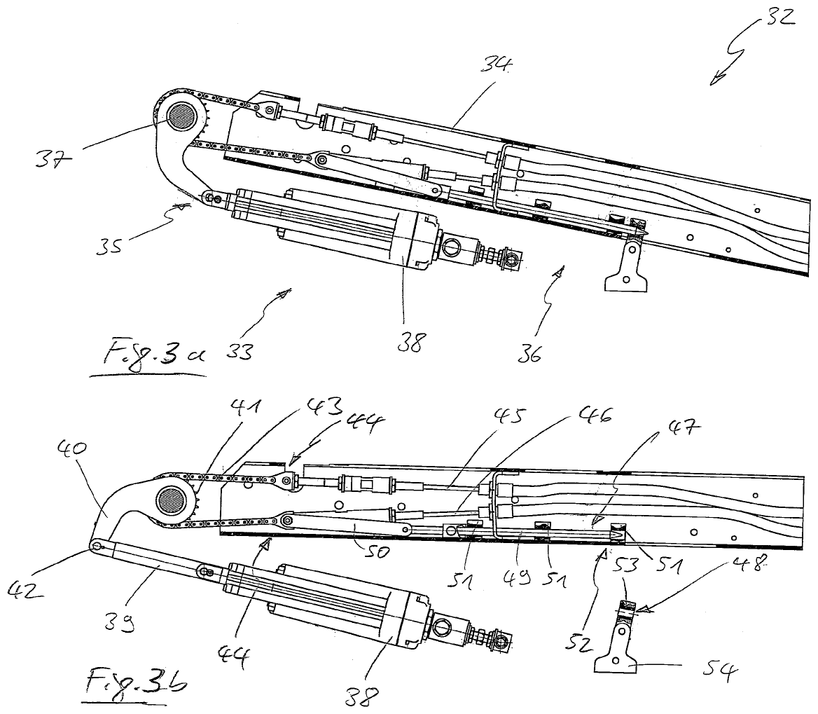

FIG. 3a is a partial section view of an articulated arm device with a drive device of a positioning unit in in a retracted position;

FIG. 3b shows the articulated arm device and the drive device after deployment from the retracted position towards a contact position.

FIG. 1 and FIG. 2 show a positioning unit 10 mounted on a roof of a vehicle (not shown), in particular an electric bus or the like. The positioning unit 10 comprises a contact device 11 for establishing an electrical contact with a charging contact device (not shown) of a charging station. The charging contact device is suspended above the vehicle roof and the contact device 11 by means of a suspension device (not shown) in the area of a stop of the vehicle. The positioning unit 10 further comprises an articulated arm device 12 composed of a pivoting device 13 having a pivoting arm 14 and a drive device 15 for driving the articulated arm device 12. The positioning unit 10 is further comprises a frame 16 for mounting the positioning unit 10 on the vehicle roof. A pivot bearing 17 is formed on the frame 16, the pivot bearing 17 forming a pivot axis 18 for the pivoting arm 14 supported on the pivot bearing 17. At an end 19 of the pivoting arm 14 opposite the pivot axis 18, the contact device 11 is disposed on a transverse guide 20. The contact device 11 is displaceable along the transverse guide 20 and can thus adapt to a situation of a charging contact device. The contact device 11, together with the transverse guide 20, at the end 19 is mounted via another pivot bearing 21, which forms another pivot axis 22 of the contact device 11. Moreover, the articulated arm device 12 has cables (not shown), which run inside the pivoting arm 14 and engage the other pivot bearing 21. During a pivoting movement of the pivoting arm 14, a continuous positioning of the contact device 11 in the contact situation shown here is thus possible.

The contact device 11 is composed of a charging contact element carrier 25 with contact elements 26 mounted on springs. The contact elements 26 are located on an upper side 27 of the charging contact element carrier 25. The contact elements 26 are connected to a terminal box (not shown) via flexible cables 28.

The drive device 15 comprises an adjustment drive 30 for generating an adjusting force acting on the pivoting arm 14, the adjustment drive 30 generating the adjusting force together with springs 31 of the drive device 15. Another adjustment drive 29 pivots the contact device 11 about the other pivot axis 22 in the retracted position (not shown). In the retracted position, the pivoting arm 14 can be firmly secured with a securing device 23, of which only an eye 24 is shown visibly here.

A combination of FIGS. 3a and 3b shows an articulated arm device 32 together with a drive device 33 of a positioning unit (not shown) in a partial section view. A pivoting arm 34 of the articulated arm device 32 is shown in a retracted position of the positioning unit in FIG. 3a and in a position outside the retracted position in the direction of a contact position in FIG. 3b. Furthermore, another adjustment drive 35 for a contact device (not shown) and a securing device 36 of the positioning unit are shown. The pivoting arm 34 is mounted to rotate about a pivot axis 37, the pivot axis 37 for its part being disposed on a frame (not shown). The other adjustment drive 35 is composed of an electric motor 38 with a spindle 39 engaging a lever 40 with a gearwheel 41 on the pivot axis 37. The other adjustment drive 35 is also attached to the frame via a pivot bearing 42. A linear movement of the spindle 39 now causes an actuation of the lever 40 and thus a rotation of the gearwheel 41. A chain 43 is disposed on the gearwheel 41, respective cables 45 and 46 being attached to each end 44 of the chain 43. Via the cables 45 and 46, a rotation of the gearwheel 41 can pivot the contact device (not shown) between a storage situation and a contact situation on another pivot axis formed on the pivoting arm 34. In the position of the other adjustment drive 35 shown in FIG. 3a, the contact device is in the storage situation, and in the position of the other adjustment drive 35 shown in FIG. 3b, the contact device is in the contact situation.

The securing device 36 is formed with a latch 47 and a recess 48, which the latch 47 engages in the contact situation of the contact device. The latch 47 is formed by a profile bar 49, which is connected to cable 46 or the end 44 of the chain 43 via a strut 50 and can thus be actuated by a movement of cable 46 or the chain 43. The profile bar 49 is longitudinally guided by a linear guide 52 formed by eyes 51. The recess 48 is also formed by an eye 53, which the profile bar 49 engages in the storage situation. Eye 53 is positioned relative to the profile bar 49 via a support 54, which is also attached to the frame. In the storage situation in the retracted position of the positioning unit or of the pivoting arm 34 as shown in FIG. 3a, the latter is firmly secured to the frame via the securing device 36, which means potential movements of the pivoting arm 34 as a result of driving movements of a vehicle can be effectively prevented. When the pivoting arm 34 moves into the contact position, the contact device is first moved into the contact situation, which is done via the other adjustment drive 35. In the process, the profile bar 49 is pulled out of eye 53 as a result of a movement of cable 46, the pivoting arm 34 thus being released. When the pivoting arm 34 moves back into the retracted position or storage situation, the pivoting arm 34 is locked by the securing device 36 in the reverse order.

1. A positioning unit for electrically driven vehicles for forming an electrically conductive connection between a vehicle and a stationary charging station, the positioning unit being configured to be disposed on a vehicle roof, a contact device of the positioning unit being configured to be moved relative to a charging contact device of the charging station and to make electrical contact therewith in a contact position, the positioning unit having an articulated arm device for positioning the contact device and a drive device, for driving the articulated arm device, the articulated arm device having a pivoting device with a pivoting arm configured to rotate on a pivot axis, the pivoting device being configured to pivot the contact device from a storage situation of a retracted position of the positioning unit for storing the contact device into a contact situation in the contact position and vice versa,
wherein
the positioning unit comprises a securing device configured to secure the pivoting arm in the storage situation in a form-fitting manner.

2. The positioning unit according to claim 1,
wherein
the articulated arm device is configured to position the contact device in the vertical direction and in the horizontal direction relative to the charging contact device and to move it into the contact position.

3. The positioning unit according to claim 1,
wherein
the securing device is coupled to the drive device in such a manner that the securing device is capable of securing the contact device in the storage situation when the contact device is pivoted into the storage situation, and the securing device is capable of releasing the contact device when the contact device is pivoted into a contact situation in the retracted position.

4. The positioning unit according to claim 1,
wherein
the contact device is disposed on an end of the pivoting arm opposite the pivot axis and configured to rotate on another pivot axis, the pivoting device being configured to pivot the contact device from the storage situation of the retracted position into a vertical contact situation in the retracted position and vice versa.

5. The positioning unit according to claim 4,
wherein
the contact device is pivoted in a direction of the pivot axis of the pivoting arm and is in contact with the pivoting arm or is pivoted in a direction opposite the pivoting arm when in the storage situation.

6. The positioning unit according to claim 1,
wherein
the positioning unit comprises a frame for mounting the positioning unit on a roof of a vehicle, the pivoting arm with the pivot axis being disposed and configured to pivot on the frame.

7. The positioning unit according to claim 6,
wherein
the securing device is formed by a latch and a recess, the latch engaging the recess in the storage situation and firmly securing the pivoting arm, the latch being disposed on the pivoting arm and the recess being disposed on the frame or vice versa.

8. The positioning unit according to claim 7,
wherein
the latch is a profile bar configured to move in a linear guide of the securing device, a catch or a pivoting hook, and the recess is formed by a protrusion, an edge, a hook, an eye or a bracket.

9. The positioning unit according to claim 1,
wherein
the drive device has an adjustment drive for generating an adjusting force acting on the pivoting arm and a spring element mechanically interacting with the adjustment drive.

10. The positioning unit according to claim 9,
wherein
the drive device has another adjustment drive for generating an adjusting force acting on the contact device.

11. The positioning unit according to claim 9,
wherein
the adjustment drive and/or the other adjustment drive has an electric motor, a cable drive, and/or a chain drive configured to rotate the pivoting arm on the pivot axis and/or to rotate the contact device on another pivot axis.

12. The positioning unit according to claim 11,
wherein
the securing device is coupled to the cable drive or the chain drive of the adjustment drive or the other adjustment drive for operation.

13. The positioning unit according to claim 1,
wherein
the contact device has a charging contact element carrier with contact elements, the contact elements being configured to make electrical contact with charging contact elements of the charging contact device when in the contact position so as to form respective contact pairs.

14. The positioning unit according to claim 1,
wherein
the pivoting device has a transverse guide configured to position the contact device in the direction perpendicular to the charging contact device, the transverse guide being disposed on an end of the pivoting arm opposite the pivot axis.

15. A fast charging system comprising a charging contact device and a positioning unit according to claim 1.

16. A method for forming an electrically conductive connection between an electrically driven vehicle and a stationary charging station using a positioning unit, a contact device of the positioning unit being moved relative to a charging contact device of the charging station and making electrical contact therewith in a contact position, an articulated arm device of the positioning unit positioning the contact device and a drive device of the positioning unit driving the articulated arm device, the articulated arm device having a pivoting device with a pivoting arm configured to rotate on a pivot axis, the pivoting device pivoting the contact device from a storage situation of a retracted position of the positioning unit for storing the contact device into a contact situation of the contact position and vice versa,
wherein
a securing device of the positioning unit secures the pivoting arm in the storage situation in a form-fitting manner.

17. The method according to claim 16,
wherein
the contact device is first pivoted from the storage situation into a vertical contact situation and then into the contact position in the vertical contact situation and vice versa.

18. The method according to claim 16,
wherein
the pivoting device always positions the contact device in the vertical contact situation while the pivoting arm is pivoting the contact device.
